(19) United States
(12) Patent Application Publication
(10) Pub. No.: US 2012/0270102 A1
(43) Pub. Date: Oct. 25, 2012

(54) Activated Carbon with Surface Modified Chemistry

(75) Inventors: Jay Whitacre, Pittsburgh, PA (US); Sneha Shanbhag, Pittsburgh, PA (US)

(73) Assignee: Aquion Energy, Inc., Pittsburgh, PA (US)

(21) Appl. No.: 13/270,847

(22) Filed: Oct. 11, 2011

Related U.S. Application Data
(60) Provisional application No. 61/392,158, filed on Oct. 12, 2010.

(51) Int. Cl. H01M 4/583; H01R 43/16; H01M 10/02

(52) U.S. Cl. 429/205; 429/231.8; 429/188; 29/874

(57) ABSTRACT

An energy storage device including an anode electrode comprising activated carbon with nitrogen containing surface groups that provide psuedocapacitive properties to the activated carbon, a cathode electrode, a separator, and an electrolyte.

### CROSS REFERENCE TO RELATED PATENT APPLICATION

The present application claims benefit of priority to U.S. provisional patent application Ser. No. 61/392,158, filed on Oct. 12, 2010 is incorporated herein by reference in its entirety.

### FIELD

The present invention is directed to electrochemical cells and in particular to hybrid energy storage devices.

### BACKGROUND

Small renewable energy harvesting and power generation technologies (such as solar arrays, wind turbines, micro sterling engines, and solid oxide fuel cells) are proliferating, and there is a commensurate strong need for intermediate size secondary (rechargeable) energy storage capability. Batteries for these stationary applications typically store between 1 and 50 kWh of energy (depending on the application) and have historically been based on the lead-acid (Pb acid) chemistry. Banks of deep-cycle lead-acid cells are assembled at points of distributed power generation and are known to last 1 to 10 years depending on the typical duty cycle. While these cells function well enough to support this application, there are a number of problems associated with their use, including: heavy use of environmentally unclean lead and acids (it is estimated that the Pb-acid technology is responsible for the release of over 100,000 tons of Pb into the environment each year in the US alone), significant degradation of performance if held at intermediate state of charge or routinely cycled to deep levels of discharge, a need for routine servicing to maintain performance, and the implementation of a requisite recycling program. There is a strong desire to replace the Pb-acid chemistry as used by the automotive industry. Unfortunately the economics of alternative battery chemistries has made this a very unappealing option to date.

Despite all of the recent advances in battery technologies, there are still no low-cost, clean alternates to the Pb-acid chemistry. This is due in large part to the fact that Pb-acid batteries are remarkably inexpensive compared to other chemistries ($200/kWh), and there is currently a focus on developing higher-energy systems for transportation applications (which are inherently significantly more expensive than Pb-acid batteries).

### SUMMARY

An embodiment relates to an energy storage device including an anode electrode comprising activated carbon with nitrogen containing surface groups that provide psuedocapacitive properties to the activated carbon, a cathode electrode, a separator, and an electrolyte.

Another embodiment relates to a method including the steps of soaking activated carbon in an acid to form soaked activated carbon having at least a 50% increase in specific capacitance over the activated carbon prior to soaking and forming an anode electrode for a secondary hybrid aqueous energy storage device from the soaked activated carbon.

### BRIEF DESCRIPTION OF THE DRAWINGS

FIG. 1 illustrates an XPS plot comparing the surface nitrogen content of unwashed and nitric acid washed activated carbon.

FIG. 2 illustrates an XPS plot comparing the surface oxygen content of unwashed and nitric acid washed activated carbon.

FIGS. 3A and 3B illustrate cyclic voltammagrams comparing the energy storage performance of unwashed and nitric acid washed activated carbons. FIG. 3C is a plot of specific capacity in units of F/g versus voltage comparing the specific capacitance performance of unwashed and nitric acid washed activated carbons.

FIG. 4 is a schematic illustration of a secondary energy storage device according to an embodiment of the present invention.

### DETAILED DESCRIPTION

Hybrid electrochemical energy storage systems of embodiments of the present invention include a double-layer capacitor electrode coupled with an active electrode. In these systems, the capacitor electrode stores charge through a reversible nonfaradiac reaction of Na cations on the surface of the electrode (double-layer) and/or pseudocapacitance, while the active electrode undergoes a reversible faradic reaction in a transition metal oxide that intercalates and deintercalates Na cations similar to that of a battery.

An example of a Li-based system has been described by Wang, et al., which utilizes a spinel structure LiMn₂O₄ battery electrode, an activated carbon capacitor electrode, and an aqueous Li₂SO₄ electrolyte. Wang, et al., Electrochemistry Communications, 7:1138-42(2005). In this system, the negative anode electrode stores charge through a reversible nonfaradiac reaction of Li-ion on the surface of an activated carbon electrode. The positive cathode electrode utilizes a reversible faradiac reaction of Li-ion intercalation/deintercalation in spinel LiMn₂O₄.

Embodiments of the invention are drawn to secondary hybrid aqueous energy storage devices and to low cost methods of making secondary hybrid aqueous energy storage devices. The inventors have discovered that soaking low specific surface area activated carbon in acid greatly increases the specific capacitance of the low specific surface area activated carbon, such as to above 120 F/g. Indeed, increases in specific capacitance of 50-100% have been attained. This result is unexpected because it is generally accepted that increases in specific capacitance in electrode materials used in energy storage devices is directly proportional to corresponding increases in electrode material specific surface area. Because of this unexpected increase in specific capacitance due to soaking low specific surface area activated carbon in acid, embodiments of present invention make it possible to make hybrid electrochemical storage devices using inexpensive, relatively low specific surface area activated carbon materials rather than using more expensive, higher specific surface area, electric double-layer capacitor (EDLC) grade activated carbon materials. For example, an embodiment of the present invention enables high specific capacitance to be achieved in an anode electrode made from treated activated carbon generated from wood, coal, or coconut precursors which generally have a finished specific surface area below 1000 m²/g (typically 600-800 m²/g) as determined by the BET method. This is in contrast to conventional anodes which are formed from more expensive EDLC grade activated carbon which typically have finished specific surface areas of 1200 m²/g or higher, such as finished specific surface areas in the range of 2000-3000 m²/g as determined by BET method, often with a lower specific capacitance. Further, the present invention is not limited to forming electrodes from treated activated carbon generated from wood, coal or coconut, but may be used to form electrodes from treated activated carbons generated from other sources without the need to select activated carbon materials with a specific surface area above 1200 m²/g. Furthermore, conventional double-layer EDCL grade activated carbon material having an ultra high specific surface area is usually made by chemical activation of an expensive precursor material, such as by chemical etching of a polymer precursor by potassium hydroxide or another alkaline etching medium. In contrast, embodiments of the present invention utilize lower cost precursor materials and physical activation, such as heating the precursor material in a carbon dioxide and/or steam ambient to form an activated carbon material having a specific surface area below 1200 m²/g, such as below 1000 m²/g and typically in the range of 600-800 m²/g. One non-limiting benefit of the embodiments of the present invention is a reduction in the manufacturing cost of the activated carbon. In particular, activated carbon with a specific surface area in the range of 600-800 m²/g with high specific capacitance (e.g., above 120 F/g) can be manufactured for less than $5/kg. In contrast, the cost of a conventional EDCL grade activated carbon with a specific surface area in the range of 2000-3000 m²/g may be more than $50/kg.

Analysis of the surface of the soaked activated carbon with X-ray photoelectron analysis (XPS) shows that the surface of the activated carbon is enriched with nitrogen containing surface groups. While not being bound by any theory, the inventors believe that these nitrogen containing surface groups provide psuedocapacitive properties to the activated carbon. Psuedocapacitance stores charge indirectly through faradaic chemical processes (e.g., electron exchange, ion adsorption, van der Waals bonding, etc.), but its electrical behavior is like that of a capacitor. That is, the electrode potential of the soaked activated carbon varies almost linearly with surface coverage (with the charge passed during an electrochemical reaction), similarly to a capacitor. An example is an electrode reaction that is limited to a monolayer on the electrode surface by surface coverage effects.

Table 1 below summarizes the results of XPS analysis of unwashed activated carbon and nitric acid washed activated carbon. Because the measured current of the photoemitted electrons is proportional to the density of atoms in the analysis volume, the atomic percent of the elements present at the surface of the samples can be computed by integrating the area under the curve for each element and determining the relative contribution of each element to the total photoemitted current. As can be seen from the table, washing activated carbon in nitric acid increases both the nitrogen and oxygen content on the surface of the activated carbon. The nitrogen content increases from 0 to 0.5 atomic percent. Preferably, the nitrogen content is greater than 0.1 atomic percent (e.g., 0.1 to 0.5 atomic percent). More preferably, the nitrogen content is great than 0.25 atomic percent, including 1 atomic percent or greater, such as 1 to 10 atomic percent (e.g. 2 to 4 atomic percent), by extending the duration of the wash and/or by increasing the nitric acid concentration. The oxygen content increase from 7.5 to approximately 17 atomic percent. Preferably, the oxygen content is greater than 10 atomic percent. In addition, Table 1 also indicates that the nitric acid wash removes surface metals from the activated carbon.

TABLE 1
Percentage Atomic Concentrations of
Elements on Activated Carbon Surface

| | Element | | | | | |
|---|---|---|---|---|---|---|
| Sample | C | O | N | Si | K | Ca |
| Unwashed AC | 90.35 | 7.5 | 0 | 0.21 | 1.04 | 0.72 |
| HNO₃ Washed AC | 78.6 | 16.94 | 0.5 | 3.92 | 0 | 0 |

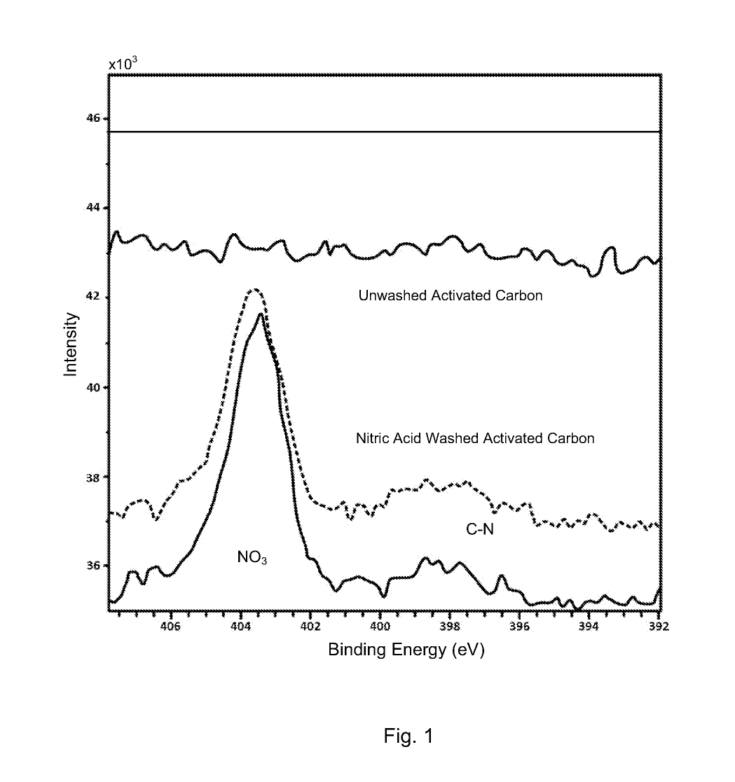

FIG. 1 illustrates an XPS scan of unwashed and nitric acid washed activated carbon. Because the electronic structure of each element is unique, determining the energy of one or more of the photoemitted electrons permits identification of the element from which it originates. The binding energy range in FIG. 1 was selected to eject photoelectrons associated with the nitrogen 1s orbital. FIG. 1 shows that post nitric acid washing, there are two distinct peaks for nitrogen surface groups, indicating that there may be two types of nitrogen surface groups on the activated carbon. The binding energies of these groups correspond to C—N bond and NO₃. This suggests that the surface of the nitric acid washed activated carbon may include bonded nitrogen and surface adsorbed nitrates. Further, the nitric acid soaked activated carbon shows hydrophilic properties which may be due to the C—N and NO₃ groups.

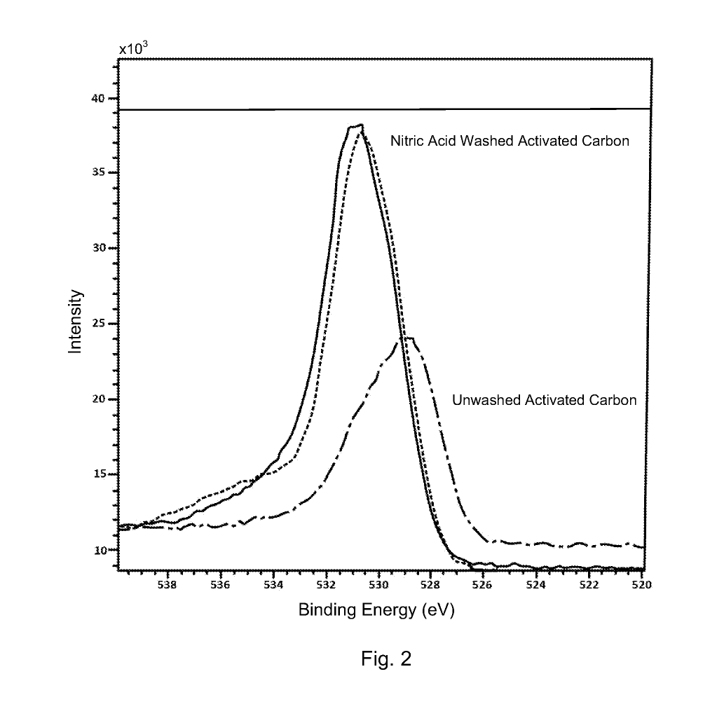

FIG. 2 illustrates another XPS scan of unwashed and nitric washed activated carbon. The binding energy range in FIG. 2, in contrast to FIG. 1, was selected to eject photoelectrons associated with the oxygen 1s orbital. FIG. 2 shows an increase in the intensity of the oxygen peak with nitric acid washing. FIG. 2 includes data (i.e., two peaks) from two nitric acid washed activated carbon samples to show repeatability. The increase in intensity indicates that nitric acid washing increases the amount of surface oxygen groups. That is, the nitric acid oxidizes the surface of the activated carbon. Oxygen containing surface groups formed on the surface of the activated carbon may include one or more of nitric, carboxyl, hydroxyl, lactone, and carbonyl. Ranges for the surface content of carboxyl, hydroxyl and lactone on the activated carbon may be (A) carboxyl 0.13-0.34 mmol/g, (B) hydroxyl 0.10-0.28 mmol/g, and (C) lactone 0.25-0.44 mmol/g.

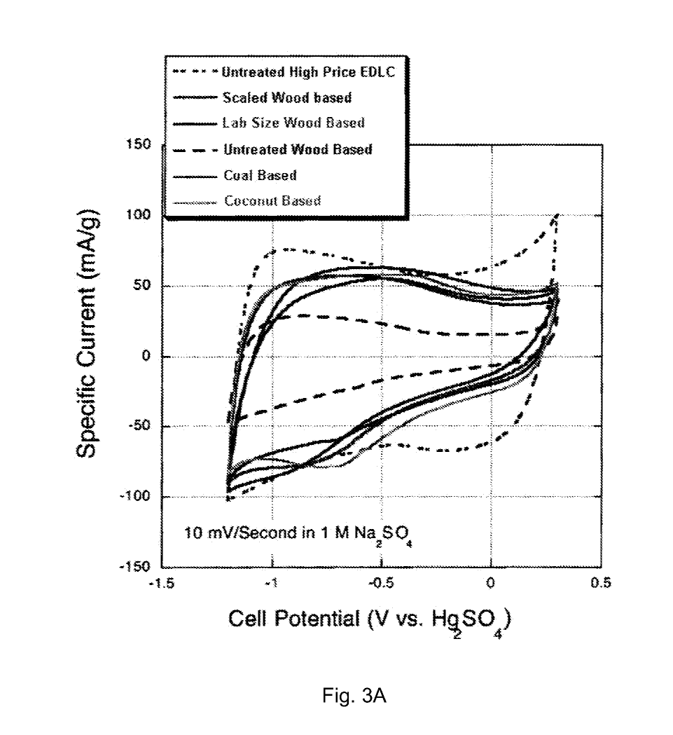

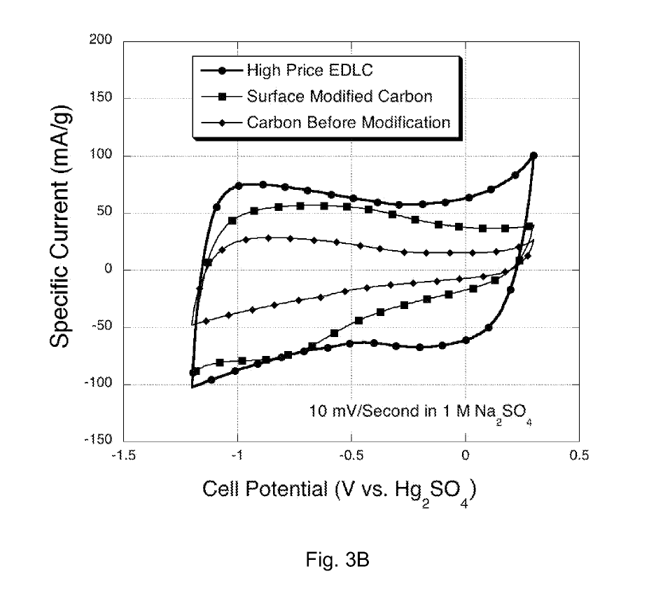

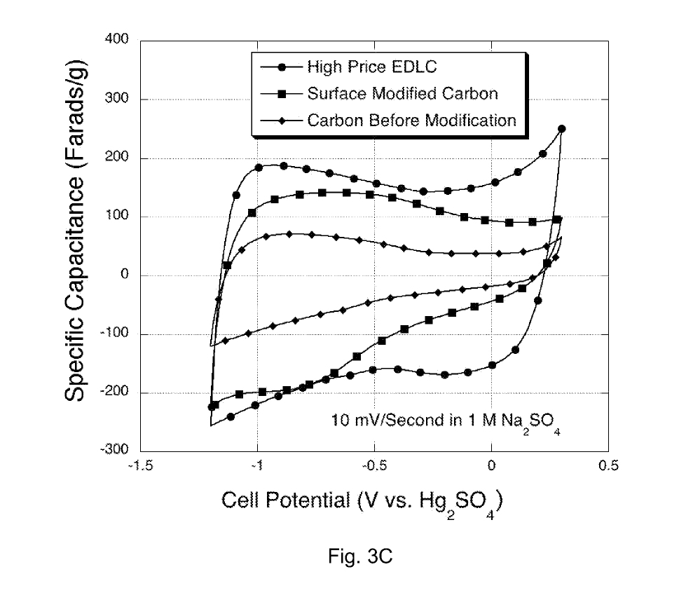

FIG. 3A illustrates cyclic voltammograms of different types of activated carbons. The area inside the current-voltage (CV) envelope is proportional to the amount of energy stored by the material per unit mass. The scaled wood based, lab size wood based, coal based, and coconut based are all surface modified low surface area activated carbons, and untreated high price EDLC is unmodified ultra high surface area activated carbon (>2500 m²/g). Also included for comparison is an untreated wood based sample. FIG. 3B is a close up of FIG. 3A which shows the cyclic voltammograms of the wood based physically activated carbon before (rhombus shapes) and after (square shapes) the nitrogen surface modification, and of the EDLC carbon (circle shapes). It can be seen that for potentials below −0.5 vs. Hg₂SO₄ the stored energy is nearly the same for the surface modified, low surface area activated carbons as for the non-modified much higher surface area activated carbon. That is, these data show that modified low surface area carbon is able to store similar amounts of energy in the lower potential ranges of interest as compared to high price EDLC carbon with a surface area approaching 3000 m²/g. All data is collected in 1 M Na₂SO₄, pH of 6.5 to 7, with a sweep rate of 10 mV/sec. Further, the asymmetric shape of the cyclic voltammograms suggest pseudocapacitive behavior.

Additionally, FIG. 3C illustrates that the nitric acid washing results in at least a 50% increase, such as 50-100% increase, in surface capacitance. For example, the surface (specific) capacitance may increase from 60-80 F/g to 110 to 200 F/g, including 110-150 F/g and 130-200 F/g, such as at least 120 F/g. As shown in FIG. 3C, the specific capacitance of the wood based, physically activated carbon (rhombus shapes) increases after the nitrogen surface modification (square shapes), and approaches that of the EDLC carbon (circle shapes).

Without wishing to be bound by a particular theory, the present inventors believe that lower surface area activated carbon, such as physically activated carbon having a surface area below 1000 m²/g (typically 600-800 m²/g) determined by BET method, has larger (i.e., wider) surface pores than the EDLC activated carbon. The larger pores make better use of the nitrogen groups located in the pores to provide an increased specific capacitance of 120 F/g or greater. This provides a value of specific capacitance per surface area of at least 0.1 F/m², such as at least 0.2 F/m², for example 0.1 to 0.35 F/m², including 0.12 to 0.33 F/m², such as 0.2 to 0.25 F/m².

Secondary (rechargeable) energy storage systems of embodiments of the present invention comprise the surface treated activated anode (i.e., negative) electrode, a carbon anode side current collector, a cathode (i.e., positive) electrode, a cathode side current collector, a separator, and an alkali or alkali earth ion (e.g., Na, Li, Mg, K and/or Ca) containing aqueous electrolyte. Any material capable of reversible intercalation/deintercalation of Na-ions (or other alkali or alkali earth metal cations, such as Li, Mg, K and/or Ca) may be used as an active cathode material.

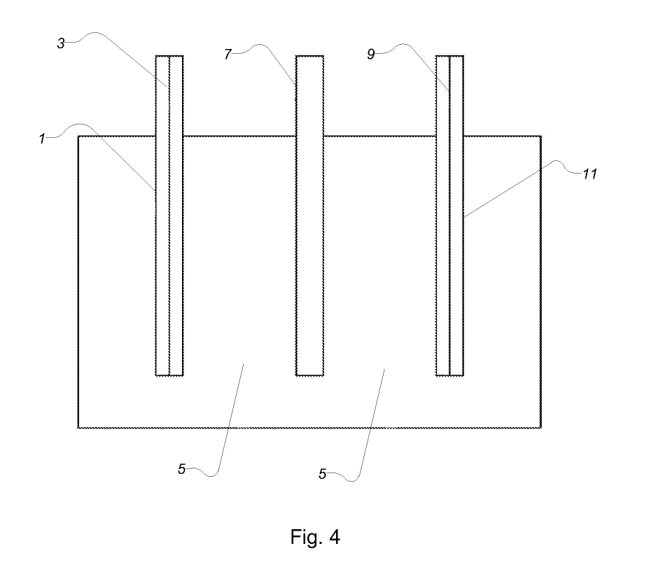

As shown in the schematic of an exemplary device in FIG. 4, the cathode side current collector 1 is in contact with the cathode electrode 3. The cathode electrode 3 is in contact with the electrolyte solution 5, which is also in contact with the anode electrode 9. The separator 7 is located in the electrolyte solution 5 at a point between the cathode electrode 3 and the anode electrode 9. The anode electrode is also in contact with the anode side current collector 11. In FIG. 4, the components of the exemplary device are shown as not being in contact with each other. The device was illustrated this way to clearly indicate the presence of the electrolyte solution relative to both electrodes. However, in actual embodiments, the cathode electrode 3 is in contact with the separator 7, which is in contact with the anode electrode 9.

Individual device components may be made of a variety of materials as follows.

### Anode

Although the anode may, in general, comprise any material capable of reversibly storing Na-ions (and/or other alkali or alkali earth ions) through surface adsorption/desorption (via an electrochemical double layer reaction and/or a pseudocapacitive reaction (i.e. partial charge transfer surface interaction)) and have sufficient capacity in the desired voltage range, anodes according to embodiments of the present invention are made of acid washed activated carbon. Preferably, organic and/or inorganic nitrogen containing acids, such as nitric acid, are used. Additional acids that may be used include, but are not limited to, sulfuric, hydrochloric, phosphoric and combinations thereof. The acid preferably has an aqueous concentration between 2 and 12 mol/1. According to one aspect, the activated carbon is soaked for at least 1 hour, such as 1-36 hours, for example 1-10 hours. Optionally, the activated carbon may be agitated during soaking. Further, the anode electrode may be dried in oxygen or air at a temperature greater than or equal to 100° C. after soaking in the acid, such as 100° C.-200° C. for 1-10 hours. If desired, the activated carbon may be rinsed in deionized water after the washing to increase the pH to 5-8.

Optionally, the anode electrode may be in the form of a composite anode comprising acid washed activated carbon, a high surface area conductive diluent (such as conducting grade graphite, carbon blacks, such as acetylene black, non-reactive metals, and/or conductive polymers), a binder, such as PTFE, a PVC-based composite (including a PVC-SiO₂ composite), cellulose-based materials, PVDF, other non-reactive non-corroding polymer materials, or a combination thereof, plasticizer, and/or a filler. A composite anode may be formed my mixing a portion of acid washed activated carbon with a conductive diluent, and/or a polymeric binder, and pressing the mixture into a pellet. In some embodiments, a composite anode electrode may be formed from a mixture from about 50 to 90 wt % acid washed activated carbon, with the remainder of the mixture comprising a combination of one or more of diluent, binder, plasticizer, and/or filler. For example, in some embodiments, a composite anode electrode may be formed from about 80 wt % activated carbon, about 10 to 15 wt % diluent, such as carbon black, and about 5 to 10 wt % binder, such as PTFE.

One or more additional functional materials may optionally be added to a composite anode to increase capacity and replace the polymeric binder. These optional materials include but are not limited to Zn, Pb, hydrated NaMnO₂ (birnassite), and hydrated Na_{0.44}MnO₂ (orthorhombic tunnel structure).

An anode electrode will generally have a thickness in the range of about 80 to 1600 μm. Generally, the anode will have a specific capacitance equal to or greater than 110 F/g, e.g. 110-150 F/g, and a specific area equal to or less than 1000 m²/g, e.g. 600-800 m²/g determined by BET method.

### Cathode

Any suitable material comprising a transition metal oxide, sulfide, phosphate, or fluoride can be used as active cathode materials capable of reversible alkali and/or alkali earth ion, such as Na-ion intercalation/deintercalation. Materials suitable for use as active cathode materials in embodiments of the present invention preferably contain alkali atoms, such as sodium, lithium, or both, prior to use as active cathode materials. It is not necessary for an active cathode material to contain Na and/or Li in the as-formed state (that is, prior to use in an energy storage device). However, for devices in which use a Na-based electrolyte, Na cations from the electrolyte should be able to incorporate into the active cathode material by intercalation during operation of the energy storage device. Thus, materials that may be used as cathodes in embodiments of the present invention comprise materials that do not necessarily contain Na in an as-formed state, but are capable of reversible intercalation/deintercalation of Na-ions during discharging/charging cycles of the energy storage device without a large overpotential loss.

In embodiments where the active cathode material contains alkali-atoms (preferably Na or Li) prior to use, some or all of these atoms are deintercalated during the first cell charging cycle. Alkali cations from a sodium based electrolyte (overwhelmingly Na cations) are re-intercalated during cell discharge. This is different than nearly all of the hybrid capacitor systems that call out an intercalation electrode opposite activated carbon. In most systems, cations from the electrolyte are adsorbed on the anode during a charging cycle. At the same time, the counter-anions, such as hydrogen ions, in the electrolyte intercalate into the active cathode material, thus preserving charge balance, but depleting ionic concentration, in the electrolyte solution. During discharge, cations are released from the anode and anions are released from the cathode, thus preserving charge balance, but increasing ionic concentration, in the electrolyte solution. This is a different operational mode from devices in embodiments of the present invention, where hydrogen ions or other anions are preferably not intercalated into the cathode active material and/or are not present in the device. The examples below illustrate cathode compositions suitable for Na intercalation. However, cathodes suitable for Li, K or alkali earth intercalation may also be used.

Suitable active cathode materials may have the following general formula during use: AₓM_{y}O_{z}, where A is Na or a mixture of Na and one or more of Li, K, Be, Mg, and Ca, where x is within the range of 0 to 1, inclusive, before use and within the range of 0 to 10, inclusive, during use; M comprises any one or more transition metal, where y is within the range of 1 to 3, inclusive; preferably within the range of 1.5 and 2.5, inclusive; and O is oxygen, where z is within the range of 2 to 7, inclusive; preferably within the range of 3.5 to 4.5, inclusive.

In some active cathode materials with the general formula AₓM_{y}O_{z}, Na-ions reversibly intercalate/deintercalate during the discharge/charge cycle of the energy storage device. Thus, the quantity x in the active cathode material formula changes while the device is in use.

In some active cathode materials with the general formula AₓM_{y}O_{z}, A comprises at least 50 at % of at least one or more of Na, K, Be, Mg, or Ca, optionally in combination with Li; M comprises any one or more transition metal; O is oxygen; x ranges from 3.5 to 4.5 before use and from 1 to 10 during use; y ranges from 8.5 to 9.5 and z ranges from 17.5 to 18.5. In these embodiments, A preferably comprises at least 51 at % Na, such as at least 75 at % Na, and 0 to 49 at %, such as 0 to 25 at %, Li, K, Be, Mg, or Ca; M comprises one or more of Mn, Ti, Fe, Co, Ni, Cu, V, or Sc; x is about 4 before use and ranges from 0 to 10 during use; y is about 9; and z is about 18.

In some active cathode materials with the general formula AₓM_{y}O_{z}, A comprises Na or a mix of at least 80 atomic percent Na and one or more of Li, K, Be, Mg, and Ca. In these embodiments, x is preferably about 1 before use and ranges from 0 to about 1.5 during use. In some preferred active cathode materials, M comprises one or more of Mn, Ti, Fe, Co, Ni, Cu, and V, and may be doped (less than 20 at %, such as 0.1 to 10 at %; for example, 3 to 6 at %) with one or more of Al, Mg, Ga, In, Cu, Zn, and Ni.

General classes of suitable active cathode materials include (but are not limited to) the layered/orthorhombic NaMO₂ (birnessite), the cubic spinel based manganate (e.g., MO₂, such as λ-MnO₂ based material where M is Mn, e.g., LiₓM₂O₄ (where 1≦x<1.1) before use and Na₂Mn₂O₄ in use), the Na₂M₃O₇ system, the NaMPO₄ system, the NaM₂(PO₄)₃ system, the Na₂MPO₄F system, and the tunnel-structured Na_{0.44}MO₂, where M in all formulas comprises at least one transition metal. Typical transition metals may be Mn or Fe (for cost and environmental reasons), although Co, Ni, Cr, V, Ti, Cu, Zr, Nb, W, Mo (among others), or combinations thereof, may be used to wholly or partially replace Mn, Fe, or a combination thereof. In embodiments of the present invention, Mn is a preferred transition metal. In some embodiments, cathode electrodes may comprise multiple active cathode materials, either in a homogenous or near homogenous mixture or layered within the cathode electrode.

In some embodiments, the initial active cathode material comprises NaMnO₂ (birnassite structure) optionally doped with one or more metals, such as Li or Al.

In some embodiments, the initial active cathode material comprises λ-MnO₂ (i.e., the cubic isomorph of manganese oxide) based material, optionally doped with one or more metals, such as Li or Al.

In these embodiments, cubic spinel λ-MnO₂ may be formed by first forming a lithium containing manganese oxide, such as lithium manganate (e.g., cubic spinel LiMn₂O₄) or non-stoichiometric variants thereof. In embodiments which utilize a cubic spinel λ-MnO₂ active cathode material, most or all of the Li may be extracted electrochemically or chemically from the cubic spinel LiMn₂O₄ to form cubic spinel λ-MnO₂ type material (i.e., material which has a 1:2 Mn to O ratio, and/or in which the Mn may be substituted by another metal, and/or which also contains an alkali metal, and/or in which the Mn to O ratio is not exactly 1:2). This extraction may take place as part of the initial device charging cycle. In such instances, Li-ions are deintercalated from the as-formed cubic spinel LiMn₂O₄ during the first charging cycle. Upon discharge, Na-ions from the electrolyte intercalate into the cubic spinel λ-MnO₂. As such, the formula for the active cathode material during operation is Na_{y}LiₓMn₂O₄ (optionally doped with one or more additional metal as described above, preferably Al), with 0<x<1, 0<y<1, and x+y≦1.1. Preferably, the quantity x+y changes through the charge/discharge cycle from about 0 (fully charged) to about 1 (fully discharged). However, values above 1 during full discharge may be used. Furthermore, any other suitable formation method may be used. Non-stoichiometric LiₓMn₂O₄ materials with more than 1 Li for every2 Mn and 4O atoms may be used as initial materials from which cubic spinel λ-MnO₂ may be formed (where 1≦x<1.1 for example). Thus, the cubic spinel λ-manganate may have a formula Al_{z}LiₓMn_{2-z}O₄ where 1≦x<1.1 and 0≦z<0.1 before use, and Al_{z}LiₓNa_{y}Mn₂O₄ where 0≦x<1.1, 0≦x<1, 0≦x+y<1.1, and 0≦z<0.1 in use (and where Al may be substituted by another dopant).

In some embodiments, the initial cathode material comprises Na₂Mn₃O₇, optionally doped with one or more metals, such as Li or Al.

In some embodiments, the initial cathode material comprises Na₂FePO₄F, optionally doped with one or more metals, such as Li or Al.

In some embodiments, the cathode material comprises Na_{0.44}MnO₂, optionally doped with one or more metals, such as Li or Al. This active cathode material may be made by thoroughly mixing Na₂CO₃ and Mn₂O₃ to proper molar ratios and firing, for example at about 800° C. The degree of Na content incorporated into this material during firing determines the oxidation state of the Mn and how it bonds with O₂ locally. This material has been demonstrated to cycle between 0.33<x<0.66 for NaₓMnO₂ in a non-aqueous electrolyte.

Optionally, the cathode electrode may be in the form of a composite cathode comprising one or more active cathode materials, a high surface area conductive diluent (such as conducting grade graphite, carbon blacks, such as acetylene black, non-reactive metals, and/or conductive polymers), a binder, a plasticizer, and/or a filler. Exemplary binders may comprise polytetrafluoroethylene (PTFE), a polyvinylchloride (PVC)-based composite (including a PVC-SiO₂ composite), cellulose-based materials, polyvinylidene fluoride (PVDF), hydrated birnassite (when the active cathode material comprises another material), other non-reactive non-corroding polymer materials, or a combination thereof. A composite cathode may be formed by mixing a portion of one or more preferred active cathode materials with a conductive diluent, and/or a polymeric binder, and pressing the mixture into a pellet. In some embodiments, a composite cathode electrode may be formed from a mixture of about 50 to 90 wt % active cathode material, with the remainder of the mixture comprising a combination of one or more of diluent, binder, plasticizer, and/or filler. For example, in some embodiments, a composite cathode electrode may be formed from about 80 wt % active cathode material, about 10 to 15 wt % diluent, such as carbon black, and about 5 to 10 wt % binder, such as PTFE.

One or more additional functional materials may optionally be added to a composite cathode to increase capacity and replace the polymeric binder. These optional materials include but are not limited to Zn, Pb, hydrated NaMnO₂ (birnassite), and hydrated Na_{0.44}MnO₂ (orthorhombic tunnel structure). In instances where hydrated NaMnO₂ (birnas site) and/or hydrated Na_{0.44}MnO₂ (orthorhombic tunnel structure) is added to a composite cathode, the resulting device has a dual functional material composite cathode. A cathode electrode will generally have a thickness in the range of about 40 to 800 μm. Preferably, the cathode electrode does not contain activated carbon (or contains less than 0.5 weigh percent activated carbon).

### Current Collectors

In embodiments of the present invention, the cathode and anode materials may be mounted on current collectors. For optimal performance, current collectors are desirable that are electronically conductive and corrosion resistant in the electrolyte (aqueous Na-cation containing solutions, described below) at operational potentials.

For example, an anode current collector should be stable in a range of approximately −1.2 to −0.5 V vs. a standard Hg/Hg₂SO₄ reference electrode, since this is the nominal potential range that the anode half of the electrochemical cell is exposed during use. A cathode current collector should be stable in a range of approximately 0.1 to 0.7 V vs. a standard Hg/Hg₂SO₄ reference electrode.

Suitable uncoated current collector materials for the anode side include stainless steel, Ni, NiCr alloys, Al, Ti, Cu, Pb and Pb alloys, refractory metals, and noble metals.

Suitable uncoated current collector materials for the cathode side include stainless steel, Ni, NiCr alloys, Ti, Pb-oxides (PbOₓ), and noble metals.

Current collectors may comprise solid foils or mesh materials.

Another approach is to coat a metal foil current collector of a suitable metal, such as Al, with a thin passivation layer that will not corrode and will protect the foil onto which it is deposited. Such corrosion resistant layers may be, but are not limited to, TiN, CrN, C, CN, NiZr, NiCr, Mo, Ti, Ta, Pt, Pd, Zr, W, FeN, CoN, etc. These coated current collectors may be used for the anode and/or cathode sides of a cell. In one embodiment, the cathode current collector comprises Al foil coated with TiN, FeN, C, or CN. The coating may be accomplished by any method known in the art, such as but not limited to physical vapor deposition such as sputtering, chemical vapor deposition, electrodeposition, spray deposition, or lamination.

### Electrolyte

Embodiments of the present invention provide a secondary (rechargeable) energy storage system which uses a water-based (aqueous) electrolyte, such as a Na-based aqueous electrolyte. This allows for use of much thicker electrodes, much less expensive separator and current collector materials, and benign and more environmentally friendly materials for electrodes and electrolyte salts. Additionally, energy storage systems of embodiments of the present invention can be assembled in an open-air environment, resulting in a significantly lower cost of production.

Electrolytes useful in embodiments of the present invention comprise a salt dissolved fully in water. For example, the electrolyte may comprise a 0.1 M to 10 M solution of at least one anion selected from the group consisting of SO₄²⁻, NO₃⁻, ClO₄⁻, PO₄³⁻, CO₃²⁻, Cl⁻, and/or OH⁻. Thus, Na cation containing salts may include (but are not limited to) Na₂SO₄, NaNO₃, NaClO₄, Na₃PO₄, Na₂CO₃, NaCl, and NaOH, or a combination thereof.

In some embodiments, the electrolyte solution may be substantially free of Na. In these instances, cations in salts of the above listed anions may be an alkali other than Na (such as Li or K) or alkaline earth (such as Ca, or Mg) cation. Thus, alkali other than Na cation containing salts may include (but are not limited to) Li₂SO₄, LiNO₃, LiClO₄, Li₃PO₄, Li₂CO₃, LiCl, and LiOH, K₂SO₄, KNO₃, KClO₄, K₃PO₄, K₂CO₃, KCl, and KOH. Exemplary alkaline earth cation containing salts may include CaSO₄, Ca(NO₃)₂, Ca(ClO₄)₂, CaCO₃, and Ca(OH)₂, MgSO₄, Mg(NO₃)₂, Mg(ClO₄)₂, MgCO₃, and Mg(OH)₂. Electrolyte solutions substantially free of Na may be made from any combination of such salts. In other embodiments, the electrolyte solution may comprise a solution of a Na cation containing salt and one or more non-Na cation containing salt.

Molar concentrations preferably range from about 0.05 M to 3 M, such as about 0.1 to 1 M, at 100° C. for Na₂SO₄ in water depending on the desired performance characteristics of the energy storage device, and the degradation/performance limiting mechanisms associated with higher salt concentrations. Similar ranges are preferred for other salts.

A blend of different salts (such as a blend of a sodium containing salt with one or more of an alkali, alkaline earth, lanthanide, aluminum and zinc salt) may result in an optimized system. Such a blend may provide an electrolyte with sodium cations and one or more cations selected from the group consisting of alkali (such as Li or K), alkaline earth (such as Mg and Ca), lanthanide, aluminum, and zinc cations.

Optionally, the pH of the electrolyte may be altered by adding some additional OH-ionic species to make the electrolyte solution more basic, for example by adding NaOH other OH⁻ containing salts, or by adding some other OH⁻ concentration-affecting compound (such as H₂SO₄ to make the electrolyte solution more acidic). The pH of the electrolyte affects the range of voltage stability window (relative to a reference electrode) of the cell and also can have an effect on the stability and degradation of the active cathode material and may inhibit proton (H⁺) intercalation, which may play a role in active cathode material capacity loss and cell degradation. In some cases, the pH can be increased to 11 to 13, thereby allowing different active cathode materials to be stable (than were stable at neutral pH 7). In some embodiments, the pH may be within the range of about 3 to 13, such as between about 3 and 6, or between 6 and 8, such as between 6.5 and 7.5, or between about 8 and 13.

Optionally, the electrolyte solution contains an additive for mitigating degradation of the active cathode material, such as birnassite material. An exemplary additive may be, but is not limited to, Na₂HPO₄, in quantities sufficient to establish a concentration ranging from 0.1 mM to 100 mM.

### Separator

A separator for use in embodiments of the present invention may comprise a cotton sheet, PVC (polyvinyl chloride), PE (polyethylene), glass fiber or any other suitable material.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An anode electrode for energy storage device, comprising activated carbon with nitrogen containing surface groups that provide psuedocapacitive properties to the activated carbon, wherein the activated carbon has a specific surface area of 1000 meters²/gram or less determined by BET method and a specific capacitance of greater than 120 farads/gram in an aqueous alkali cation based electrolyte.

2. The electrode of claim 1, wherein the activated carbon has the specific surface area of 600-800 m²/g, the specific capacitance of greater or equal to 130 farads/gram, and a specific capacitance per surface area of at least 0.1 F/m².

3. The electrode of claim 2, wherein the activated carbon has the specific capacitance of 130-200 farads/gram and a specific capacitance per surface area of 0.1 to 0.35 F/m².

4. The electrode of claim 1, wherein the activated carbon has a specific surface area of 600 meters²/gram or less determined by BET method.

5. The electrode of claim 1, wherein:
the nitrogen containing surface groups comprise at least one of C-N or C-NO₃;
a content of nitrogen on a surface of the activated carbon is greater than 0.25 atomic percent;
the activated carbon comprises physically activated carbon;
the activated carbon comprises activated carbon soaked in nitric acid; and
the activated carbon comprises one or more surface groups selected from the group consisting of nitro, C—N, carboxyl, hydroxyl, lactone, and carbonyl.

6. The electrode of claim 5, wherein the content of nitrogen on the surface of the activated carbon is 1-10 atomic percent.

7. The electrode of claim 1, wherein:
the anode electrode is located in a hybrid energy storage device which further comprises a cathode electrode, a separator, and an aqueous alkali cation based electrolyte;
the cathode electrode in operation reversibly intercalates alkali metal cations; and
the anode electrode comprises a capacitive electrode which stores charge through a reversible nonfaradiac reaction of alkali metal cations on a surface of the anode electrode or a pseudocapacitive electrode which undergoes a partial charge transfer surface interaction with alkali metal cations on a surface of the anode electrode.

8. The device of claim 7, wherein:
the device comprises a secondary hybrid aqueous energy storage device;
the cathode electrode in operation reversibly intercalates sodium cations;
the cathode electrode does not contain activated carbon;
an initial active cathode electrode material in the device comprises an alkali metal containing active cathode electrode material which deintercalates alkali metal ions during initial charging of the device; and
the electrolyte comprises an aqueous electrolyte containing sodium cations and having a pH of 6.5 to 7.5.

9. The device of claim 8, wherein:
the active cathode electrode material comprises a doped or undoped cubic spinel λ-MnO₂-type material;
the doped or undoped cubic spinel λ-MnO₂-type material is formed by either providing a lithium manganate cubic spinel material and then removing at least a portion of the lithium during the initial charging to form the λ-MnO₂-type material, or by providing a lithium manganate cubic spinel material, chemically or electrochemically removing at least a portion of the lithium, and performing a chemical or electrochemical ion exchange to insert sodium into alkali metal sites of the λ-MnO₂-type material; and
the electrolyte comprises Na₂SO₄ solvated in water, and initially excludes lithium ions.

10. The device of claim 8, wherein the initial active cathode electrode material comprises:
a doped or undoped Na₂MPO₄F material, where M comprises at least one transition metal; or
a doped or undoped tunnel structured Na_{0.44}MO₂ material, where M comprises at least one transition metal.

11. A method comprising:
soaking activated carbon in an acid to form soaked activated carbon having at least a 50% increase in specific capacitance over the activated carbon prior to soaking; and
forming an anode electrode for a secondary hybrid aqueous energy storage device from the soaked activated carbon.

12. The method of claim 11, wherein the acid is selected from the group consisting of nitric, sulfuric, hydrochloric, phosphoric and combinations thereof; and
the anode electrode is dried in oxygen or air at a temperature greater than or equal to 100° C. after soaking.

13. The method of claim 12, wherein the acid comprises nitric acid, and wherein the acid has an aqueous concentration between 2 and 12 mol/l.

14. The method of claim 11, wherein:
the activated carbon has a specific surface area of 1000 meters/gram or less determined by BET method;
the soaked activated carbon is oxidized during the soaking and the activated carbon comprises one or more surface groups selected from the group consisting of nitro, C—N, carboxyl, hydroxyl, lactone, and carbonyl;
the specific capacitance of the soaked activated carbon increases from less than 80 farads/gram in a neutral pH electrolyte comprising Na₂SO₄ solvated in water to greater than 120 farads/gram;
the activated carbon comprises wood, coconut or coal based physically activated carbon; and
the soaking is performed for at least 1 hour while agitating the activated carbon and the acid during the soaking.

15. The method of claim 11, wherein the secondary hybrid aqueous energy storage device further comprises:
a cathode electrode which in operation reversibly intercalates alkali cations;
a separator; and
the alkali cation containing aqueous electrolyte.

16. The method of claim 15, further comprising:
deintercalating alkali metal ions from an initial active cathode electrode material comprising an alkali metal containing active cathode electrode material during initial charging of the device, wherein the active cathode electrode material comprises a doped or undoped cubic spinel λ-MnO₂-type material, the electrolyte has a pH of 6.5 to 7.5, and the alkali cations comprise sodium cations; and
forming the doped or undoped cubic spinel λ-MnO₂-type material by either providing a lithium manganate cubic spinel material and then removing at least a portion of the lithium during the initial charging to form the λ-MnO₂-type material, or by providing a lithium manganate cubic spinel material, chemically or electrochemically removing at least a portion of the lithium, and performing a chemical or electrochemical ion exchange to insert sodium into alkali metal sites of the λ-MnO₂-type material.

17. The method of claim 15, wherein the initial active cathode electrode material comprises a doped or undoped Na₂MPO₄F material, where M comprises at least one transition metal or a doped or undoped tunnel structured Na_{0.44}MO₂ material, where M comprises at least one transition metal.

18. The method of claim 15, wherein the electrolyte comprises Na₂SO₄ solvated in water, and initially excludes lithium ions, and wherein the activated carbon has a specific surface area of 1000 meters²/gram or less determined by BET method, a specific capacitance of greater than 120 farads/gram in the aqueous alkali cation based electrolyte, and a specific capacitance per surface area of at least 0.1 F/m².

19. A method of making an electrode, comprising:
forming an activated carbon with a specific surface area below 1200 m²/g;
treating the activated carbon to form nitrogen surface groups thereon wherein the content of nitrogen on the surface of the activated carbon is 1-10 atomic percent; and
forming the activated carbon into an electrode which has a specific capacitance per surface area of at least 0.1 F/m².

20. The method of claim 19, further comprising placing the electrode into an energy storage device which further comprises a cathode electrode, a separator and an aqueous alkali cation based electrolyte, wherein the electrode comprises an anode electrode which has a specific capacitance per surface area of at least 0.1 F/m² in the aqueous alkali cation based electrolyte.
